(19) United States
(12) Patent Application Publication
(10) Pub. No.: US 2007/0029247 A1
(43) Pub. Date: Feb. 8, 2007

(54) Apparatus to separate waste from wastewater

(75) Inventor: Joel E. Alpert, Sharon, MA (US)

Correspondence Address: BURNS & LEVINSON, LLP;(FORMERLY PERKINS SMITH & COHEN LLP), 125 SUMMER STREET, BOSTON, MA, 02110, US

(73) Assignee: Compost and Technology Solutions, Inc.

(21) Appl. No.: 11/197,228

(22) Filed: Aug. 4, 2005

(51) Int. Cl. C02F 1/28; C02F 1/40

(52) U.S. Cl. 210/287; 210/799

(57) ABSTRACT

An apparatus for separating fats, oils, and greases (FOGs) and miscible organics that are present in the wastewater from businesses, institutions, and industries such as restaurants, hospitals, and food processing plants. The apparatus can be installed in situ or can be mobile. The apparatus provides for wastewater to flow through a network of fluid channels, for example a distribution pipe, on to an absorption/filtration media within a substantially watertight container. The wastewater percolates through the absorption/filtration media leaving FOGs behind inside the container, which have been absorbed by the organic absorption/filtration media. Fluid, free of the organic waste, flows through a fluid removal pipe at the bottom of the container, thereby exiting the container. The organic absorption/filtration media saturated with organic waste can then be treated in an environmentally sensitive manner by composting, land application, incineration or land filling at a remote site or composted on site.

### FIELD OF THE INVENTION

The invention relates to the field of treating wastewater, and more specifically, a system for separating and retaining fats, oils, greases (FOGs) and miscible organics from wastewater, thereby allowing safe and economical treatment of both the wastewater and the separated organic material.

### BACKGROUND OF THE INVENTION

Fats, oils, and greases (FOGs) and miscible organics (hereinafter collectively referred to as “organic wastes”) that are present in the waste water from businesses, institutions, and industries such as restaurants, hospitals, and food processing plants congeal in the conveyance pipes that lead to the municipal or other water treatment plants whose function is to purify the water to the degree that it can be safely reused or released to the environment. This causes backups and sewage overflows in the conveyance systems that are environmentally hazardous and costly to clean up. Furthermore, FOGs (Organic wastes) have a high oxidation demand, which can interrupt normal biological processing in the wastewater treatment plant.

As a consequence of the problems created by the presence of FOGs (Organic wastes) and miscible organics, many municipalities and states in the United States of America and other countries around the world are requiring restaurants, institutions, food processing plants, and other generators of organic waste streams to install grease traps to collect the organic fraction prior to entry into the wastewater conveyance systems.

These trapped organic wastes have a high moisture content (92-98% water) and high oxygen demand. Current practice is to store these wastes in tanks and routinely pump them out of the storage tanks and transport them by tanker truck to remote locations. At these locations they are treated in special wastewater treatment facilities or mechanically dewatered with the organic fraction either incinerated or treated by composting or land application. The current practice of sporting the organic laden wastewater great distances is costly and inefficient and has the further disadvantages of adding to congestion on the roads and unfavorable environmental impact as a result of truck emissions.

There is a need to provide a system for separating fats, oils, greases, and miscible organics from wastewater.

There is another need to provide a system for separating fats, oils, greases, and miscible organics from the wastewater produced in a facility, which can be installed on site at the point at which the wastewater exits the facility.

There is an additional need to provide an efficient, relatively inexpensive, environmentally friendly process for treatment of waste water that contains fats, oils, greases, and miscible organics.

Further purposes and advantages of this invention will appear as the description proceeds.

### SUMMARY OF THE INVENTION

The various embodiments of the present invention pertain to the separation of the organic wastes and miscible organics from wastewater exiting a facility such as food related businesses, institutions, and industries, either with or without grease traps, in order to produce an fluid which can be discharged into a municipal wastewater treatment plant or meet the standards for on site disposal either above or below ground.

The concept of the present invention is to provide a substantially watertight container filled with absorption/filtering media to absorb or otherwise remove FOG from wastewater from a restaurant or other enterprise. Wastewater is introduced into the top of the container, and the organic waste is selectively absorbed by the absorption/filtering media, thereby separating it from the water. The filtered water without the organic waste drains to the bottom of the container and from there into the municipal sewerage system or other disposal holding system.

Periodically, a truck comes to the site and mixes or agitates the absorption/filtering media to break up the surface crust and provides new surface area to allow for more absorptive capacity in the material. Periodic inspections of the quality of the wastewater are carried out either manually or automatically. When it is determined that the absorption/filtering media is saturated and no longer effective, then the material is replaced and the material containing the absorbed organic wastes is then either hauled off to a central compost facility, a land application site, a landfill, an incinerator, or potentially composted on site (in the container by attaching a blower to maintain aerobic conditions).

The subsequent descriptions will be directed towards the treatment of wastewater with high levels of organic wastes and miscible organics from food related establishments. It should be understood that the invention could also be used to treat wastewater of high organic strength from other types of facilities as well e.g. facilities for manufacturing home care products or paint. The system as described can be utilized as either a continuous or batch process as will be described hereinbelow.

One aspect of the present invention of the organic waste separating apparatus includes a sealable container, a hinged or removable or otherwise movable cover, and a network of wastewater input ports and fluid outlet ports disposed in or integral to the sealable container and removable cover.

The sealable container can include a chamber, a top opening, and an outlet port. The chamber includes a top portion, a bottom portion, and two opposing inwardly inclined chamber bottom surfaces. The chamber is of sufficient volume to hold absorption media plus a certain amount of unfiltered wastewater (freeboard).

In one embodiment of the present invention a pipe is disposed below the chamber. The pipe includes a plurality of holes disposed along a top surface to allow fluid from the chamber to enter into the pipe.

The hinged or removable cover seals the top opening of the sealable container. In one embodiment of the removable cover of the present invention, the removable cover includes a bottom surface, at least one inlet port, and a plurality of organic waste distribution plenums disposed along the bottom surface of the removable cover in fluid communication with at least one inlet port to deposit the organic waste within the chamber.

The chamber also can include an inclined fluid channel, for example a false bottom, disposed in proximity of the bottom portion of the chamber. The inclined fluid channel is in fluid communication with the outlet port and the chamber permitting the transfer of fluid from the chamber to an external disposal source connected to the outlet port, whereby waste products contained within the organic waste are substantially absorbed by the absorption/filtration media and the residual fluid can be safely disposed of according to environmental procedures.

Other embodiments of the present invention illustrated herein disclose alternative inclined fluid channels and options that included an absorption/filtration media mixer/agitator and blower.

All the above and other characteristics and advantages of the invention will be further understood through the following illustrative and non-limitative description of preferred embodiments thereof, with reference to the appended drawings.

### BRIEF DESCRIPTION OF THE DRAWINGS

For a more complete understanding of the present invention and the advantages thereof, reference is now made to the following description taken in conjunction with the accompanying Drawings in which:

FIG. 1 is a perspective view showing one embodiment of an organic waste separating apparatus of the present invention;

FIG. 2 is a cross-sectional view of the present invention taken along line A-A in FIG. 1;

FIG. 3 is a cross-sectional view of the present invention taken along line B-B in FIG. 1;

FIG. 4 schematically shows a portable mixer adaptable to the organic waste separating apparatus of the present invention illustrated in FIG. 1;

FIG. 5 is a perspective view showing a blower adapted to the organic waste separating apparatus of the present invention illustrated in FIG. 1;

FIG. 6 is a top view of a fluid removal pipe of the present invention illustrated in FIG. 1; and

FIG. 7 is a bottom view of a distribution pipe of the present invention illustrated in FIG. 1.

### DETAILED DESCRIPTION OF PREFERRED EMBODIMENTS

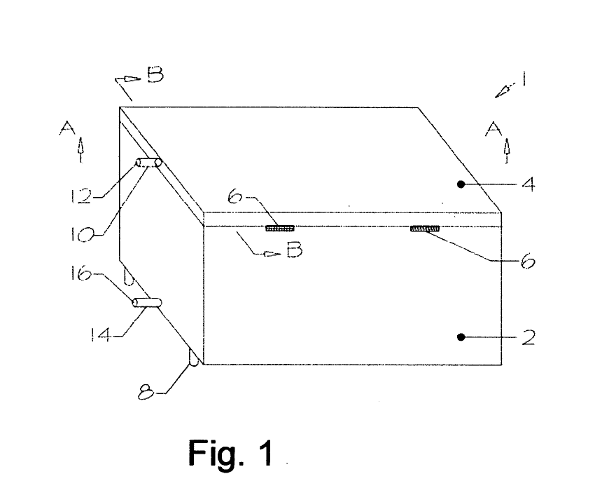

Referring now to FIGS. 1, 2 and 3 illustrating views of an organic waste separating apparatus 1 of the present invention FIG. 1 is a perspective view showing the organic waste separating apparatus 1 of the present invention of the system of the invention. Organic waste separating apparatus 1 includes a sealable container 2 having a top opening 2A that is preferably water tight and made of high density plastic or corrosion resistant metal. Container 2 has a removable cover 4 attached to it by hinges 6 to substantially seal or close top opening 2A to keep vectors from the organic matrix and wastes, and to keep odors enclosed in the system. Cover 4 is preferably closed at all times except when the absorption/filtering media 22 is being added, mixed/agitated, or removed.

Organic waste separating apparatus 1 can be fitted with a plurality of extensions 8 along its exterior bottom surface 2B, such as legs and/or roller devices (for example, wheels or casters), to raise it off the ground and/or allow it to be rolled from place to place.

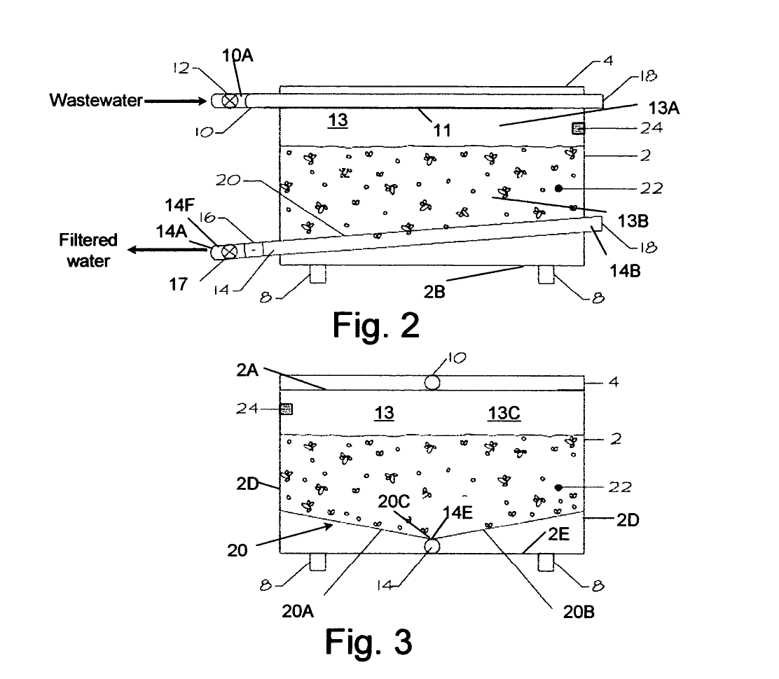

Affixed to the inside surface of container cover 4 are one or more plastic or corrosion resistant metal distribution pipes 10 to form a network of fluid channels. One end 10A of the distribution pipe 10 includes an inlet port 15 for connection to the wastewater outlet of, for example, a fast food restaurant, via a flexible hose or pipe (not shown). Preferably, a valve and/or other suitable connector 12 is disposed at end 10A for closure inlet port 15. Distribution pipe 10 includes a plurality of organic waste distribution ports (such as holes 10B, FIG. 7) spaced, preferably evenly spaced, along bottom surface 11 to distribution of the wastewater over the surface of the absorption/filtering media. Thereby, placing plurality of organic waste distribution ports in fluid communication with inlet port 15. The organic waste distribution ports 10B must be large enough to allow the wastewater to flow smoothly. The distribution pipe 10 is fitted with a cleanout port 18 (see FIG. 2) at the end of the pipe opposite end of connector 12 to remove any large object which could clog the distribution pipe 10.

For large systems, multiple pipes 10 or fluid channels may be utilized to even out the spread of the wastewater on the surface of the absorption/filtration media 22.

The interior or chamber 13 of the organic waste separating apparatus 1 can be seen in FIGS. 2 and 3. FIG. 2 is a cross-sectional taken along line A-A of FIG. 1 and FIG. 3 is a cross-sectional view taken along line B-B if FIG. 1. The chamber 13 includes a top portion 13A and a bottom portion 13B. The volume of interior or chamber 13 is of sufficient volume for absorption/filtration media 22 to fill most of the interior or chamber 13 of container 2. The interior or chamber 13 of container 2 is not filled to the top with absorption/filtration media 22 to allow a freeboard zone 13C where the wastewater (or organic waste) can sit if it is applied at a rate greater than the conductivity through the absorption/filtration media 22.

The absorption/filtration media 22 is organic in nature, such as woodchips, bark, yard waste, or other wood derived products, which are slightly hydrophobic but will absorb organic waste. Waste products contained within the wastewater are substantially absorbed by the absorption/filtration media 22 as the wastewater percolates through the absorption/filtration media 22. The residual fluid, such as water, is separated for safe disposal according to environmental standards. The absorption/filtration media 22 can be, for example, comprised of chips of varying size in order to increase the surface area in contact with the wastewater while allowing a good infiltration rate and conductivity through the matrix.

At the bottom portion 13B of container 2 can be a false bottom 20 made of either high density plastic or corrosion resistant metal. One example of the false bottom 20 is an inclined fluid channel 20C defined by two downwardly opposing inclined chamber bottom surfaces 20A, 20B. As illustrated in FIG. 2, false bottom 20, for example, can be inclined or slanted downward toward the lower end 14A of fluid removal pipe 14. As illustrated in FIG. 3, false bottom 20, for example, can be inclined or slanted in two opposing directions to allow the fluid to go to the center and rapidly drain from the container 2. The illusion is not to limit the false bottom 20 to any particular angle of inclination or slant, or number of bottom surface segments. Another example of an acceptable false bottom 20 may only include one bottom surface forming a fluid channel 20C with a side 2D of the container 2.

There are many alternative embodiments of the false bottom 20 configuration for separating the water from the absorption/filtration media 22. One embodiment includes the false bottom 20 being preferably hermetically sealed to the walls 2D of the container 2 and to the sides of an fluid removal pipe 14. A fluid removal pipe 14 can be disposed below the interface of bottom surfaces 20A, 20B. Fluid removal pipe 14 includes a plurality of holes 14H (FIG. 6) along its top surface 14E which will allow fluid, but not the absorption/filtration media 22, to drain from the container 2.

At the lower end 14A of fluid removal pipe 14, after it passes through the wall of container 2, is located an fluid outlet port 14F. Optional, a sampling port 16 followed by a valve and/or other type of connector 17 may also be located at the lower end 14A. Connector 17 is connected to a hose or pipe, which conducts the fluid to the wastewater conveyance system, i.e. the manhole and sewer pipes leading to the public or private wastewater treatment plant, or to a surface or below ground treatment system. The upper end 14B of the fluid removal pipe 14 is fitted with a clean out port 18.

Another embodiment of the false bottom configuration of the present invention includes the false bottom 20 being a single surface hermetically sealed to the walls 2D of container 2 and a plurality of holes in the false bottom 20. The fluid removal pipe being located in the volume between the false bottom and the actual bottom 2E of container 2 into which the fluid will drain.

Another embodiment of the false bottom configuration of the present invention can be a single bottom surface or a pair of opposing bottom surfaces that form a fluid channel downwardly inclined toward said at least one fluid outlet port directly connected to connector 17, thereby eliminating fluid removal pipe 14.

At the sampling port 16 the fluid will be tested for one or more of the following parameters: pH, conductivity, biochemical oxygen demand (BOD), organics content, or other similar parameter depending on the characterstics of the wastewater. Numerous types of testing devices can be used, e.g. dyes, pH meters, spectrophotometers, or conductivity meters. The fluid is tested according to a fixed schedule e.g. every evening, on a random spot check basis, automatically and nearly continuously if suitable automation and control systems are provided or every time the media is mixed.

Alternative embodiments of the present invention may include a sensor 24 near the top portion 13A of container 2, which will signal a warning (such as an audible signal, data signal, or visual signal) if the water level rises to high.

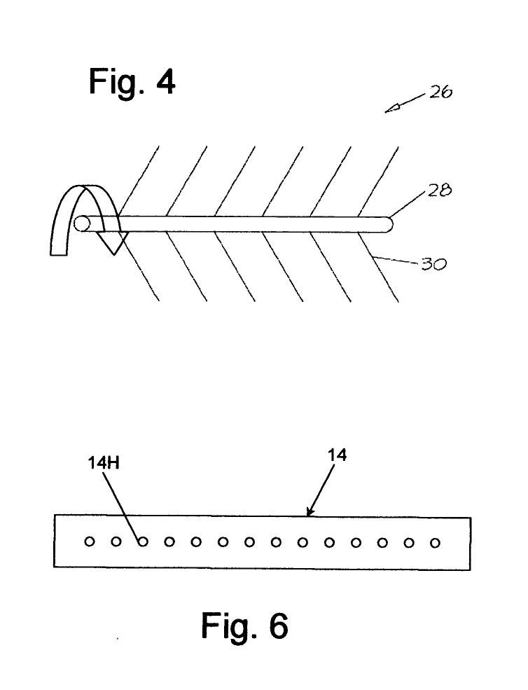

Periodically, a separate truck equipped with a portable mixer 26, such as one schematically shown in FIG. 4, will visit a site having the organic waste separating apparatus 1. When the truck arrives, removable cover 4 of container 2 will be raised and mixer 26 will be dropped through top opening 2A of container 2 and onto the top of the media 22. Mixer 26 comprises a plurality of tines 30 attached to a central shaft 28. Shaft 28 is attached to a motor (not shown). The motor causes shaft 28 to rotate and tines 30 to break up the surface crust and mix or agitate the absorption/filtration media 22, thereby reducing the potential for surface clogging and increasing the absorptive capacity of the media. The frequency of the mixing will be a function of wastewater loading and characteristics.

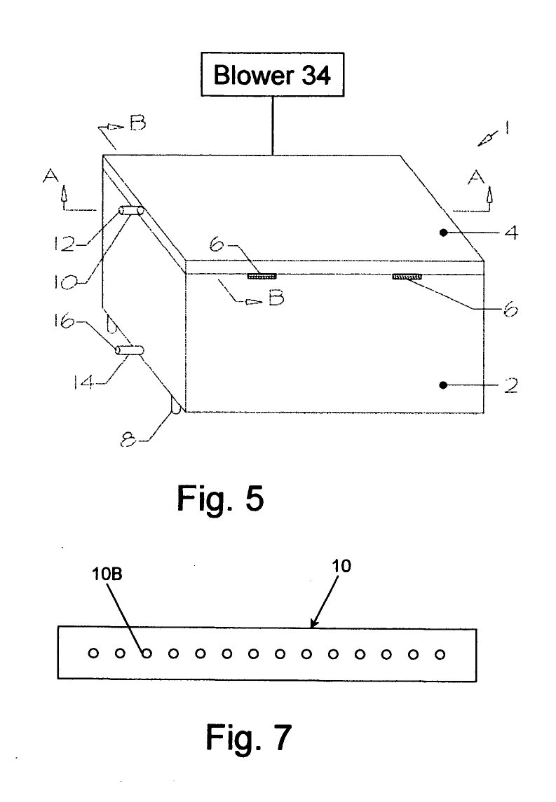

Now turning to FIG. 5, an alternative embodiment of the present invention may include a blower 34 in fluid communication with the chamber 13 of container 2 to maintain aerobic conditions within the container 2. When the results of the test performed on the fluid at the sampling port 16 indicates that the absorption/filtration media 2 is saturated to the point that it is no longer effectively removing the organic waste from the wastewater, then the distribution pipe 10, for example, is disconnected from the wastewater outlet of the facility and the absorption/filtration media 2 saturated with the organic waste is composted within the container 2.

Typically at each mixing, the fluid will be tested to determine if the absorption/filtration media 2 is saturated to the point that it is no longer effectively removing the organic waste from the wastewater. If absorption/filtration media 2 is saturated, then a number of scenarios are possible including, but not limited, to the following:

(1) The truck that comes to mix the media can carry a replacement container filled with fresh absorption/filtration media that is placed on the ground near the original container. The input and outlet lines are disconnected from the original container and reconnected to the replacement container. The container containing the absorption/filtration media saturated with organic waste is loaded on the truck and transported to a tip station where the absorption/filtration media is removed from the container. The container is cleaned out and reloaded with fresh media and readied to be brought to a new site. At the tip station, the absorption/filtration media saturated with organic waste is either offloaded into a storage tank or directly into the collection box for separation of excess water. The water is then easily treated by a wastewater treatment plant or by surface disposal. The absorption/filtration media and saturated organic waste is then either composted, for example by windrow compositing; be land applied; or added to a landfill or bioreactor. In a very much less preferred embodiment, the media and absorbed organic waste can be incinerated.

(2) The absorption/filtration media can be replaced with fresh absorption/filtration media on site. In this scenario, the truck that comes to mix the absorption/filtration media carries an empty tank and a supply of fresh absorption/filtration media. The absorption/filtration media saturated with organic waste is tipped out of the container into the tank on the truck, the container is refilled with fresh media, and the saturated absorption/filtration media is disposed of as in the first scenario.

(3) There can be two or more containers of the present invention placed at each site. After the absorption/filtration media has been mixed one or more times and the measurements indicate that the absorption/filtration media in the first container has become saturated, the input and outlet lines are disconnected from the first container and connected to a second container that contains fresh absorption/filtration media. The first container is then turned into a bioreactor for composting the absorption/filtration media in the container with the aid of a blower and periodic mixing or agitation to maintain aerobic conditions. Upon completion of the composting process, typically in about ten days, the compost is removed from the container and can be used either locally or sold. The empty container is refilled with fresh absorption/filtration media and is ready to be used to treat the wastewater when the absorption/filtration media in the second container becomes saturated.

(4) In the case of small facilities, it might not be economically viable to have an organic waste separating apparatus of the present invention placed permanently on site. Typically, the wastewater containing organic waste could be temporarily stored in a storage tank on site. Currently, a tanker truck would come to the site to empty the storage tank and take the wastewater to an offsite water treatment facility for treatment. Alternatively, an organic waste separating apparatus of the present invention can be mounted on a truck that periodically visits the site. The stored wastewater is introduced into the distribution pipe on the top of the organic waste separating apparatus on the truck and fluid exits through the fluid removal pipe into the municipal sewerage system or is otherwise disposed of on site. This procedure reduces transportation costs since only the absorption/filtration media saturated with the organic waste is transported to the treatment site and not large amounts of fluid.

Although the preferred embodiment has been described in detail, it should be understood that various changes, substitutions and alterations can be made therein without departing from the spirit and scope of the invention as defined by the appended claims and the Doctrine of Equivalents.

1. An waste separating apparatus comprising:
a sealable container having a chamber, a top opening, and at least one outlet port;
said chamber includes a top portion and a bottom portion, wherein said chamber being of sufficient volume to hold absorption media;
a movable cover to close said top opening;
said movable cover includes a bottom surface, at least one inlet port, and a plurality of distribution ports disposed along said bottom surface in communication with said at least one inlet port to deposit the waste within said chamber, and
an inclined fluid channel disposed in proximity of said bottom portion of said chamber, said inclined fluid channel being in communication with said at least one outlet port and said chamber,
whereby waste is separated for safe disposal.

2. The apparatus according to claim 1 wherein said inclined fluid channel is a pipe disposed below said chamber, said pipe having a plurality of holes disposed along a top surface of said pipe to allow fluid in said chamber to enter said pipe.

3. The apparatus according to claim 1 wherein said inclined fluid channel is defined by two downwardly opposing inclined chamber bottom surfaces.

4. The apparatus according to claim 1 wherein said inclined fluid channel is at least one chamber bottom surface.

5. The apparatus according to claim 1 further comprising at least one inclined chamber bottom surface downwardly inclined toward said at least one outlet port

6. The apparatus according to claim 1 further comprising a valve connected to said at least one inlet port.

7. The apparatus according to claim 1 wherein said movable cover further comprises at least one distribution pipe having a cleanout port.

8. The apparatus according to claim 1 further comprising a valve connected to said at least one outlet port.

9. The apparatus according to claim 1 wherein said inclined fluid channel comprises at least one distribution pipe having a cleanout port.

10. The apparatus according to claim 1 further comprising a sensor located within said top portion of said chamber to signal a warning when the water level rises to high within said chamber.

11. The apparatus according to claim 1 wherein said sealable container further comprises a plurality of extensions to elevate said sealable container above supporting surface.

12. The apparatus according to claim 11 wherein said plurality of extensions being roller devices.

13. The apparatus according to claim 1 comprising a connector connected to said at least one outlet port for attachment to an external disposal source.

14. The apparatus according to claim 1 further comprising a mixer adapted to said chamber to agitate absorption media within said chamber.

15. The apparatus according to claim 1 further comprising a sample port connected to aid at least one outlet port for testing chemistry of the fluid.

16. The apparatus according to claim 1 further comprising a blower adapted to said sealable container for fluid communication with said chamber.

17. The apparatus according to claim 1 wherein said volume of said chamber further comprises a freeboard space for unfiltered wastewater.

18. An waste separator apparatus comprising:
a sealable container having a chamber, a top opening, and an outlet port;
said chamber includes a top portion, a bottom portion, two opposing inwardly inclined chamber bottom surfaces, and said chamber being of sufficient volume to hold absorption media;
a movable cover to cover said top opening;
said movable cover includes a bottom surface, at least one inlet port, and a plurality of distribution ports disposed along said bottom surface in fluid communication with said at least one inlet port to deposit the waste within said chamber;
a pipe disposed below said chamber, wherein said pipe includes a plurality of holes disposed along a top surface to allow fluid in said chamber to enter into said pipe; and
an inclined fluid channel disposed in proximity of said bottom portion of said chamber, said inclined fluid channel being in communication with said outlet port and said chamber,
whereby waste is separated for safe disposal.
